(19) United States
(12) Patent Application Publication
(10) Pub. No.: US 2025/0310492 A1
(43) Pub. Date: Oct. 2, 2025

(54) PROJECTION-TYPE DISPLAY DEVICE

(71) Applicant: SEIKO EPSON CORPORATION, Tokyo (JP)

(72) Inventors: Toru AOKI, Shiojiri-shi (JP); Kazuhisa MIZUSAKO, Shiojiri-shi (JP); Yusuke KOMURO, Azumino-shi (JP)

(73) Assignee: SEIKO EPSON CORPORATION, Tokyo (JP)

(21) Appl. No.: 19/092,240

(22) Filed: Mar. 27, 2025

(30) Foreign Application Priority Data
Mar. 28, 2024 (JP) 2024-053372

(51) Int. Cl. H04N 9/31; G09G 3/00

(52) U.S. Cl. CPC H04N 9/3155; G09G 3/002; G09G 3/007; H04N 9/3129; H04N 9/3138; H04N 9/3152

(57) ABSTRACT

A data signal corresponding to a gradation level designated by pixel data forming video data is supplied to a panel pixel for each of unit periods f-1 to f-4, and shifting of an optical path for each of the unit periods f-1 to f-4 is controlled with respect to an optical path shifting element. The optical path shifting element shifts the optical path by 1.0 panel pixel or more in, for example, the up-down direction, which is selected from the right-left direction and the up-down direction in which projection pixels are arrayed, from the unit periods f-4 to f-1 among the unit periods f-1 to f-4, for example. Further, the light source is turned off or dimmed for at least a part or an entirety of a period during which the optical path is shifted.

The present application is based on, and claims priority from JP Application Serial Number 2024-053372, filed Mar. 28, 2024, the disclosure of which is hereby incorporated by reference herein in its entirety.

### BACKGROUND

### 1. Technical Field

The present disclosure relates to a projection-type display device.

### 2. Related Art

There has been known a technique of achieving pseudo improvement in resolution using an optical path shifting element for a projection-type display device that projects image light generated by a liquid crystal panel or the like onto a screen or the like. Specifically, in the projection-type display device, a single frame period is divided into a plurality of unit periods. A projection position of one panel pixel in the liquid crystal panel is shifted for each of the plurality of unit periods. Thus, gradation levels designated by video pixel data is expressed individually (see JP-A-2021-139968, for example).

However, in the technique described above, over the course of a single frame period, display unevenness caused by shifting of the projection position is visually recognized, and a problem of degradation of display quality arises.

### SUMMARY

In order to solve the problem described above, a projection-type display device according to an aspect of the present disclosure includes a light source according to emit light, a liquid crystal panel including a panel pixel on which light emitted from the light source is incident, an optical path shifting element configured to shift an optical path of a projection light from the panel pixel so that a position of the projection pixel is changed for each of k unit periods from a first unit period to a k-th unit period in a single frame period, k is an integer equal to or greater than 2, and a display control circuit configured to control the light source, the liquid crystal panel, and the optical path shifting element, wherein the display control circuit supplies a data signal to the panel pixel for each of the unit periods, the data signal corresponding to a gradation level designated by pixel data forming video data, and controls shifting of the optical path for each of the unit periods with respect to the optical path shifting element, the optical path shifting element shifts, during at least one unit period of the unit periods, the optical path of the projection light by one or more panel pixels in at least one direction of a first direction and a second direction in which the projection pixels are arrayed, and the light source is turned off or dimmed for at least a part or an entirety of a period during which the optical path is shifted.

### BRIEF DESCRIPTION OF THE DRAWINGS

FIG. 1 is a diagram illustrating a projection-type display device according to a first embodiment.

FIG. 2 is a block diagram illustrating a configuration of the projection-type display device.

FIG. 3 is a diagram illustrating a relationship between an array of video pixels and an array of panel pixels in the projection-type display device.

FIG. 4 is a diagram illustrating a relationship between a single frame period and unit periods in the projection-type display device.

FIG. 5 is a diagram illustrating a projection position in the single frame period.

FIG. 6 is a diagram illustrating a control signal to an optical path shifting element and a lamp unit.

FIG. 7 is a perspective view illustrating a configuration of a liquid crystal panel in the projection-type display device.

FIG. 8 is a cross-sectional view illustrating a structure of the liquid crystal panel.

FIG. 9 is a block diagram illustrating an electrical configuration of the liquid crystal panel.

FIG. 10 is a diagram illustrating a configuration of a pixel circuit in the liquid crystal panel.

FIG. 11 is a diagram illustrating a relationship between video pixels, panel pixels, and projection positions in the single frame period.

FIG. 12 is a diagram illustrating a projection position in a single frame of a projection-type display device according to a second embodiment.

FIG. 13 is a diagram illustrating a control signal to an optical path shifting element and a lamp unit.

FIG. 14 is a diagram illustrating a relationship between a double frame period and unit periods in a projection-type display device according to a third embodiment.

FIG. 15 is a diagram illustrating projection positions of the projection-type display device.

FIG. 16 is a diagram illustrating a control signal to an optical path shifting element and a lamp unit.

FIG. 17 is a diagram illustrating projection positions of a projection-type display device according to a fourth embodiment.

FIG. 18 is a diagram illustrating a control signal to an optical path shifting element and a lamp unit.

FIG. 19 is a diagram illustrating projection positions of a projection-type display device according to a comparative example.

FIG. 20 is a diagram for describing degradation of display quality in the comparative example.

### DESCRIPTION OF EMBODIMENTS

Hereinafter, a projection-type display device according to an embodiment is described with reference to the drawings. Note that, in each of the drawings, dimensions and scales of respective portions are appropriately different from actual ones. Further, since embodiments to be described below are preferred specific examples, various technically preferable limitations are applied, but the scope of the present disclosure is not limited to these embodiments unless it is otherwise stated in the following description that the present disclosure is limited.

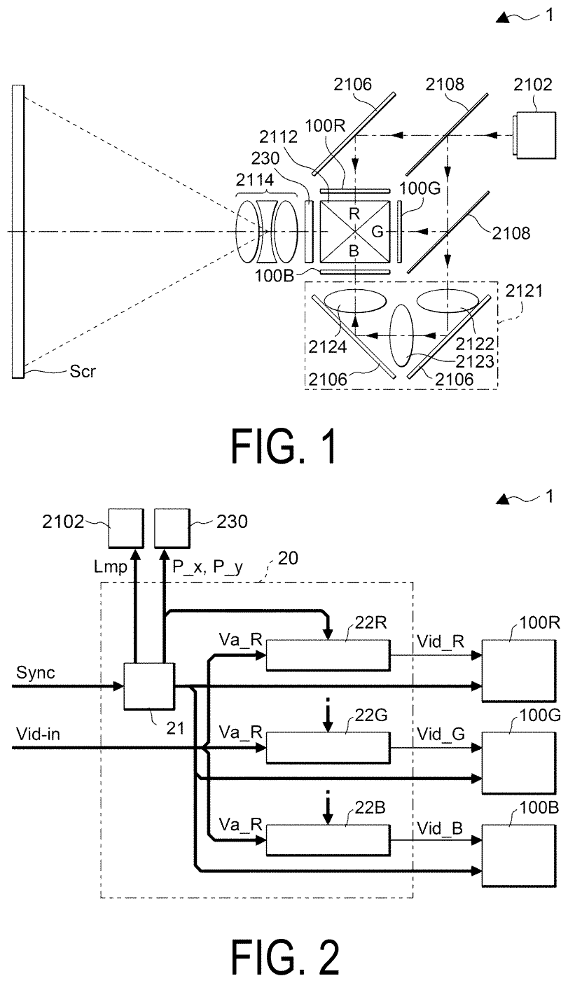

FIG. 1 is a diagram illustrating an optical configuration of a projection-type display device 1 according to a first embodiment. As illustrated in the figure, the projection-type display device 1 includes liquid crystal panels 100R, 100G, and 100B. A lamp unit 2102, and three mirrors 2106 and two dichroic mirrors 2108 are provided inside the projection-type display device 1.

The lamp unit 2102 emits white light by an LED or a laser light source. The white light emitted from the lamp unit 2102 is separated into three primary colors of red (R), green (G), and blue (B) by the two dichroic mirrors 2108.

Of these, the R light is incident on the liquid crystal panel 100R, the G light is incident on the liquid crystal panel 100G, and the B light is incident on the liquid crystal panel 100B.

Note that, since an optical path of B is longer than optical paths of R and G, it is necessary to prevent loss in the optical path of B. To this end, a relay lens system 2121 including an incidence lens 2122, a relay lens 2123, and an emission lens 2124 is provided in the optical path of B.

The liquid crystal panel 100R includes a plurality of pixel circuits as described below. Each of the plurality of pixel circuits includes a liquid crystal element. The liquid crystal element of the liquid crystal panel 100R is driven based on a data signal corresponding to R. As a result, a transmittance corresponding to the voltage of the data signal is obtained.

To this end, the transmittance of the liquid crystal element is individually controlled based on the data signal corresponding to R so that a transmission image of R is generated in the liquid crystal panel 100R. Similarly, in the liquid crystal panel 100G, a transmission image of G is generated based on a data signal corresponding to G. In the liquid crystal panel 100B, a transmission image of B is generated based on a data signal corresponding to B.

The transmission images of respective colors generated by the liquid crystal panels 100R, 100G, and 100B, respectively, are incident on the dichroic prism 2112 from three directions. In the dichroic prism 2112, the R and B light are refracted at 90 degrees, while the G light travels straight. The dichroic prism 2112 therefore combines the images of the respective colors. The combined image generated by the dichroic prism 2112 is incident on a projection lens 2114 through an optical path shifting element 230.

The projection lens 2114 enlarges and projects the combined image via the optical path shifting element 230 onto a screen Scr.

The optical path shifting element 230 shifts the optical path of the combined image light emitted from the dichroic prism 2112. Specifically, the optical path shifting element 230 shifts the combined image projected onto the screen Scr in the right-left direction and/or in the up-down direction with respect to a projection surface.

Note that the transmission images from the liquid crystal panels 100R and 100B are projected after being reflected by the dichroic prism 2112, whereas the transmission image from the liquid crystal panel 100G is projected in a straight line. Thus, the transmission images respectively from the liquid crystal panels 100R and 100B are laterally inverted with respect to the transmission image from the liquid crystal panel 100G.

FIG. 2 is a block diagram illustrating an electrical configuration of the projection-type display device 1. As illustrated in the figure, the projection-type display device 1 includes a display control circuit 20, the above-described liquid crystal panels 100R, 100G, and 100B, the optical path shifting element 230, and the lamp unit 2102.

Video data Vid-in is supplied from a higher-level device such as a host device (omitted in illustration) in synchronization with a synchronization signal Sync. The video data Vid-in designates a gradation level of pixels in an image constituting a single frame period of a video, for example, in 8 bits for each R, G, and B.

Note that the pixel of the image designated by the video data Vid-in is referred to as a video pixel, and data for designating the gradation level of the video pixel is referred to as video pixel data, but the video pixels and the video pixel data may not be particularly distinguished from each other in the description. Further, a pixel of an image before or after the combination in the liquid crystal panel 100R, 100G, or 100B is referred to as a panel pixel. The position of the panel pixel that is shifted by the optical path shifting element 230 and projected onto the screen Scr is referred to as a projection position.

In the liquid crystal panels 100R, 100G, and 100B, panel pixels are arrayed in a matrix in plan view. In the embodiment, an array of the video pixels designated by the video data Vid-in is, for example, twice as large in a vertical direction and twice as large in a horizontal direction as an array of the panel pixels from the liquid crystal panel 100R, 100G, or 100B.

In the embodiment, a color image projected onto the screen Scr is expressed by combining the respective transmission images of the liquid crystal panels 100R, 100G, and 100B. Thus, the minimum units of the color image can be classified into a red sub-pixel corresponding to the liquid crystal panel 100R, a green sub-pixel corresponding to the liquid crystal panel 100G, and a blue sub-pixel corresponding to the liquid crystal panel 100B. However, when there is no need to specify the colors of the sub-pixels in the liquid crystal panels 100R, 100G, and 100B, or, for example, when the brightness is simply the problem, there is no need to use the term sub-pixel in the first place. Therefore, in the description herein, a unit of displaying by the liquid crystal panels 100R, 100G, and 100B is also referred to as a panel pixel.

The synchronization signal Sync includes a vertical synchronization signal that instructs a start of vertical scanning of the video data Vid-in, a horizontal synchronization signal that instructs a start of horizontal scanning, and a clock signal that indicates timing for one video pixel in the video data Vid-in.

The display control circuit 20 includes a processing circuit 21, and conversion circuits 22R, 22G, and 22B.

The processing circuit 21 controls the conversion circuits 22R, 22G, and 22B, the liquid crystal panels 100R, 100G, and 100B, the optical path shifting element 230, and the lamp unit 2102, based on the synchronization signal Sync for each of the unit periods f-1 to f-4. The optical path shifting element 230 shifts the projection position according to control signals P_x and P_y supplied from the processing circuit 21. The lamp unit 2102 turns off or dims the emission light under control of a control signal Lmp supplied from the processing circuit 21.

Note that, in the embodiment, the lamp unit 2102 turns off the emission light under control of the processing circuit 21. Alternatively, the lamp unit 2102 may dim the light. In other words, the lamp unit 2102 may be configured to perform switching between a first state, which is a light-on state when the light is emitted, and a second state, which is a state darker than the light-on state.

In the video data Vid-in supplied from a higher-level device, an R component is denoted as pixel data Va_R, a G component is denoted as pixel data Va_G, and a B component is denoted as pixel data Va_B.

The conversion circuit 22R temporarily stores the video data Va-R supplied from a higher-level device for one or more frame periods in an internal buffer, reads video data corresponding to a unit period, converts the video data into an analog voltage data signal Vid R, and supplies the data signal to the liquid crystal panel 100R. The conversion circuits 22G and 22B are different from the conversion circuit 22R only in a color component of the video data being a conversion target, and are similar to the conversion circuit 22R in other respects. In other words, the conversion circuit 22G converts the video data Va-G into an analog voltage data signal Vid_G corresponding to a unit period, and supplies the data signal to the liquid crystal panel 100G, and
the conversion circuit 22B converts the video data Va-B into an analog voltage data signal Vid_B corresponding to a unit period, and supplies the data signal to the liquid crystal panel 100B.

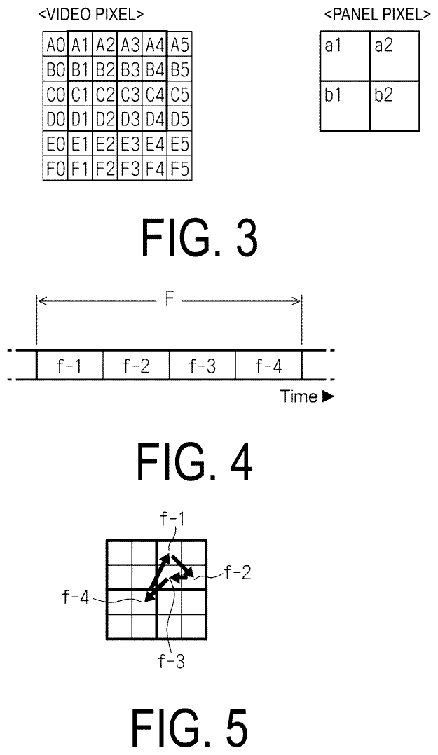

FIG. 3 is a diagram for describing a relationship between video pixels and panel pixels in the projection-type display device 1.

Specifically, in FIG. 3, the left column is a diagram illustrating a part extracted from an array of the video pixels represented by the video data Vid-in, and the right column is a diagram illustrating an extracted array corresponding to the array of the video pixels in the left column.

In the array in the left column, for the sake of convenience, symbols A0 to A5 are assigned to a first row, B0 to B5 to a second row, C0 to C5 to a third row, D0 to D5 to a fourth row, E0 to E5 to a fifth row, and F0 to F5 to a sixth row in order to distinguish between the video pixels in the image represented by the video data Vid-in. Similarly, in the array in the right column of FIG. 3, for the sake of convenience, symbols a1 and a2 are assigned to a first row, and b2 and b3 to a second row in order to distinguish between the panel pixels.

FIG. 4 is a diagram for describing a frame period and unit periods in the projection-type display device 1 according to the first embodiment. As illustrated in the figure, in the embodiment, a single frame (F) period is divided into four unit periods. Note that, for the sake of convenience, symbols f1, f2, f3, and f4 are assigned in chronological order in order to distinguish the four unit periods.

Note that the single frame period is a period during which a single frame of an image represented by the video data Vid-in from a higher-level device is supplied, and is 16.7 milliseconds, which is one cycle, when a frequency of the vertical synchronization signal included in the synchronization signal Sync is 60 Hz. In this case, the length of each of the unit periods is ¼ of the length of the single frame period, which is 4.17 milliseconds.

In the embodiment, when the processing circuit 21 controls the optical path shifting element 230, the projection position is changed for each of the unit periods f-1 to f-4.

In one unit period, a user visually recognizes an image achieved by reducing the resolution of an image for a single frame period designated by the video data Vid-in to one fourth of the original resolution, as the combined image by the liquid crystal panels 100R, 100G, and 100B.

Note that, hereinafter, when the liquid crystal panels 100R, 100G, and 100B are generally described without specifying the color, description is made by using the reference sign 100.

FIG. 5 is a diagram illustrating a relationship of video pixels expressed by one panel pixel for each of the unit periods f-1 to f-4. In other words, the drawing illustrates the projection position in the unit periods f-1 to f-4.

Note that, when the panel pixel “represents” a certain video pixel, this means a state in which the liquid crystal element 120 of the panel pixel has a transmittance corresponding to the gradation level (video pixel data) of the video pixel. Further, in the drawing, for the sake of convenience, the video pixels in the two rows and two columns are surrounded by the thick frame.

The optical path shifting element 230 shifts the image projected onto the screen Scr in the up-down direction and the right-left direction with respect to the projection surface. For the sake of convenience, an amount of the shift is described in terms of the size of the pixel projected onto the screen Scr, that is, the size of the panel pixel.

The projection position in the unit period f-1 is set as a reference position. In the unit period f-2, the projection position is shifted to the reference position in the unit period f-1, by 0.5 panel pixels in the rightward direction and 0.5 panels pixels in the downward direction in the drawing. In other words, the projection position is shifted diagonally downward to the right.

In the unit period f-3, the projection position is shifted from the projection position in the unit period f-2 by 0.5 pixels in the leftward direction. In the unit period f-4, the projection position is shifted from the projection position in the unit period f-3 by 0.5 panel pixels in the rightward direction and 0.5 panel pixels in the downward direction. In other words, the projection position is shifted diagonally downward to the left. After the unit period f-4, the projection position is shifted from the projection position in the unit period f-4 by 0.5 panel pixels in the rightward direction and 1.0 panel pixel in the upward direction, and returns to the reference position.

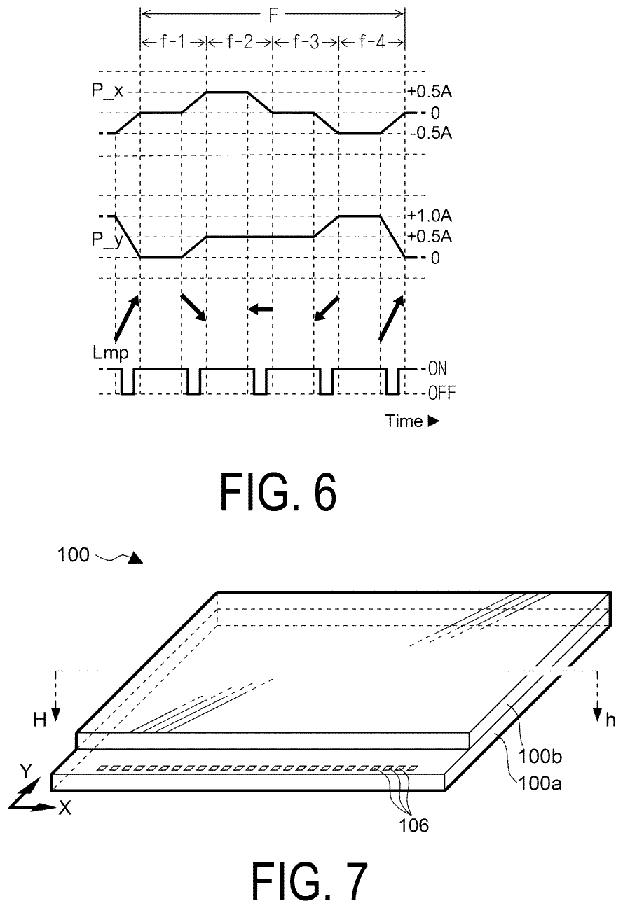

FIG. 6 is a diagram illustrating waveforms of the control signals P_x and P_y to the optical path shifting element 230, and the like when the panel pixels represent the video pixels as illustrated in FIG. 5.

In the first embodiment, the control signal P_x has a level of one of three values including −0.5 A, 0, and +0.5 A in a period other than a rear end period of the unit periods f1 to f4. Further, the control signal P_y has a level of one of three values including 0, +0.5 A, and +1.0 A in a period other than the rear end period of the unit periods f1 to f4.

The levels of the control signals P_x and P_y are changed in the rear end period. The rear end period is a period after a vertical scanning effective period during which first to m-th scanning lines 12 are selected in a unit period, and a period corresponding to a vertical scanning retrace period. Further, the level of the control signal P_x or P_y may be constant over two consecutive unit periods.

The arrow illustrated in the rear end period of each of the unit periods in FIG. 6 indicates a direction in which the projection position is shifted when the levels of the control signals P_x and P_y are changed in that rear end period.

Next, the liquid crystal panels 100R, 100G, and 100B are described. The liquid crystal panels 100R, 100G, and 100B are structurally the same, with only color, that is, wavelength, of incident light being different. Therefore, the liquid crystal panels 100R, 100G, and 100B are generally described as the liquid crystal panel 100 without specifying the color.

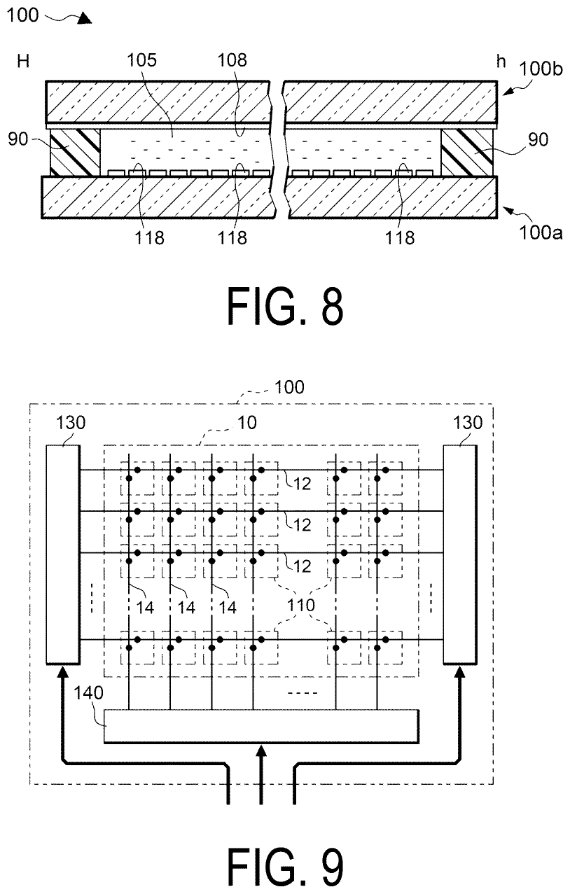

FIG. 7 is a perspective view illustrating the liquid crystal panel 100, and FIG. 8 is a cross-sectional view taken along the line H-h in FIG. 7.

As illustrated in the figure, in the liquid crystal panel 100, an element substrate 100a on which pixel electrodes 118 are provided and a counter substrate 100b on which a common electrode 108 is provided are bonded together by a seal material 90 so that electrode formation surfaces face each other while maintaining a certain gap, and this gap is sealed with a liquid crystal 105.

As the element substrate 100a and the counter substrate 100b, a light-transmitting substrate such as glass or quartz may be used. As illustrated in FIG. 7, one side of the element substrate 100a protrudes from the counter substrate 100b. In this protruding area, a plurality of terminals 106 are provided along a horizontal direction in the drawing. One end of a flexible printed circuit (FPC) substrate (omitted in illustration) is coupled to the plurality of terminals 106. Note that the other end of the FPC substrate is coupled to the display control circuit 20, and the above-described various signals are supplied.

On a surface of the element substrate 100a facing the counter substrate 100b, the pixel electrodes 118 are formed by patterning a transparent conductive layer such as an Indium Tin Oxide (ITO).

Further, although not particularly illustrated, a microlens (omitted in illustration) is provided for each panel pixel on the counter substrate 100b (or the element substrate 100a) in order to efficiently send a large amount of light to an opening that becomes the panel pixel. With this configuration, light repelled by a light shielding portion is sent to an opening of the microlens, improving the efficiency of light utilization.

FIG. 9 is a block diagram illustrating an electrical configuration of the liquid crystal panel 100. The liquid crystal panel 100 is provided with a scanning line driving circuit 130 and a data line driving circuit 140 on a periphery of the display area 10.

In the display area 10 of the liquid crystal panel 100, pixel circuits 110 are arrayed in a matrix. Specifically, in the display area 10, a plurality of scanning lines 12 are provided to extend in a horizontal direction in the figure, and a plurality of data lines 14 are provided to extend in a vertical direction and to be electrically insulated from the scanning lines 12. The pixel circuits 110 are provided in a matrix to correspond to intersections between the plurality of scanning lines 12 and the plurality of data lines 14.

When the number of scanning lines 12 is m and the number of data lines 14 is n, the pixel circuits 110 are arrayed in a matrix of m vertical rows and n horizontal columns. Both m and n are integers equal to or greater than 2. In the scanning lines 12 and the pixel circuits 110, the rows of the matrix may be referred to as 1st, 2nd, 3rd, . . . , (m−1)th, and m-th rows from the top in the figure in order to distinguish between the rows of the matrix. Similarly, in the data lines 14 and the pixel circuits 110, the columns of the matrix may be referred to as 1st, 2nd, 3rd, . . . , (n−1)th, and nth columns from the left in the figure in order to distinguish between the columns of the matrix.

The scanning line driving circuit 130 selects the scanning lines 12 one by one in order of, for example, the first, second, third, m-th rows under the control of the display control circuit 20, and sets a scanning signal to the selected scanning line 12 to a H level. Note that the scanning line driving circuit 130 sets a scanning signal to the scanning lines 12 other than the selected scanning line 12 to a L level.

The data line driving circuit 140 latches a data signal for one row supplied from the circuit for corresponding color among the conversion circuits 22R, 22G, and 22B, and outputs the data signal to the pixel circuit 110 located on the scanning line 12 via the data line 14 during a period in which the scanning signal to the scanning lines 12 is at the H level.

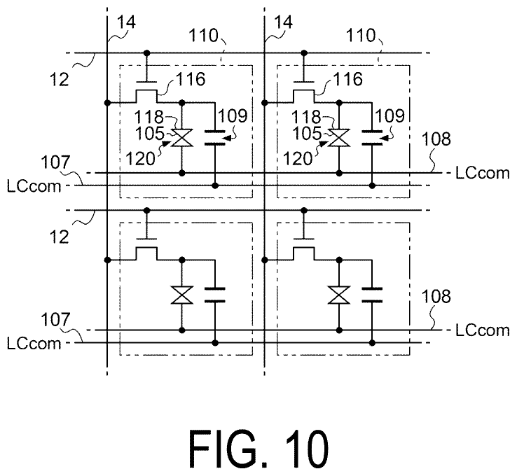

FIG. 10 is a diagram illustrating an equivalent circuit of four pixel circuits 110 in total including two vertical rows and two horizontal columns that correspond to intersections of two adjacent scanning lines 12 and two adjacent data lines 14.

As illustrated in the figure, the pixel circuit 110 includes a transistor 116 and a liquid crystal element 120. The transistor 116 is, for example, an n-channel thin film transistor. In the pixel circuit 110, the transistor 116 has a gate node coupled to the scanning line 12, a source node coupled to the data line 14, and a drain node coupled to the pixel electrode 118 having a square shape in plan view.

The common electrode 108 is provided in common to all the pixels to face the pixel electrode 118. A voltage LCcom is applied to the common electrode 108. Further, as described above, the liquid crystal 105 is sandwiched between the pixel electrodes 118 and the common electrode 108. Therefore, the liquid crystal element 120 in which the liquid crystal 105 is sandwiched between the pixel electrodes 118 and the common electrode 108 is formed in each pixel circuit 110.

Further, a storage capacitor 109 is provided in parallel with the liquid crystal element 120. The storage capacitor 109 has one terminal coupled to the pixel electrode 118, and the other terminal coupled to a capacitance line 107. A voltage that is constant over time such as the voltage LCcom that is the same as the voltage applied to the common electrode 108 is applied to the capacitance line 107. Since the pixel circuits 110 are arrayed in a matrix in a horizontal direction, which is a direction in which the scanning lines 12 extend, and a vertical direction, which is a direction in which the data lines 14 extend, the pixel electrodes 118 included in the pixel circuits 110 are also arrayed in the vertical and horizontal directions.

In the scanning line 12 on which the scanning signal reaches the H level, the transistor 116 of the pixel circuit 110 provided to correspond to the scanning line 12 enters an on state. When the transistor 116 is turned on, the data line 14 and the pixel electrode 118 are electrically coupled, and thus, the data signal supplied to the data line 14 reaches the pixel electrode 118 via the transistor 116 that is previously turned on. When the scanning line 12 becomes at the L level, the transistor 116 enters an off state, but a voltage of the data signal that previously reaches the pixel electrode 118 is held by a capacitance of the liquid crystal element 120 and the storage capacitor 109.

As is well known, in the liquid crystal element 120, orientation of liquid crystal molecules changes depending on an electric field generated by the pixel electrode 118 and the common electrode 108. Therefore, the liquid crystal element 120 has a transmittance according to an effective value of an applied voltage.

Note that a region of the liquid crystal element 120 that functions as a panel pixel, that is, a region of a transmittance according to the effective value of the voltage is a region where the pixel electrode 118 and the common electrode 108 overlap when the element substrate 100a and the counter substrate 100b are viewed in plan view. Since the pixel electrode 118 is square in plan view, a shape of the pixel in the liquid crystal panel 100 is also square.

Further, in the embodiment, the liquid crystal 105 is of a vertical alignment (VA) type, and is in a normally black mode in which a transmittance is lowest when a voltage applied to the liquid crystal element 120 is zero, and increases as the applied voltage increases.

An operation of supplying a data signal to the pixel electrode 118 of the liquid crystal element 120 is executed in order of 1st, 2nd, 3rd, . . . , m-th rows in each of the unit periods f1 to f4. Accordingly, a voltage corresponding to the data signal is held in each of the liquid crystal elements 120 of the pixel circuits 110 arrayed in the m rows and the n columns, each liquid crystal element 120 has a desired transmittance, and a transmission image of the corresponding color is generated by the liquid crystal elements 120 arrayed in the m rows and the n columns.

Thus, the generation of a transmission image is executed for each R, G, and B, and a color image obtained by combining R, G, and B is projected onto the screen Scr.

The data signals Vid R, Vid_G, and Vid_B output corresponding to a certain unit period correspond to R, G, and B components of the video data corresponding to the unit period. To this end, a combined image of a color corresponding to the projection position is projected at the projection position in the unit period.

Next, description is made on how a user visually recognizes the video pixels by the panel pixels in the projection-type display device 1 according to the embodiment.

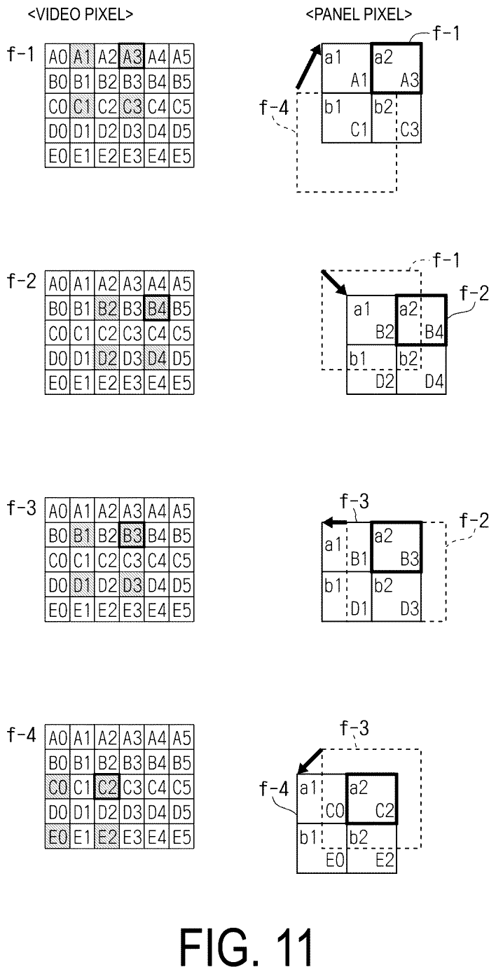

FIG. 11 is a diagram illustrating which video pixel is expressed at which projection position by the panel pixel in the projection-type display device 1. Specifically, FIG. 11 is a diagram illustrating projection positions in the unit periods f-1 to f-4 at which the video pixels in the left column in the FIG. 3 are expressed by four panel pixels a1, a2, b1, and b2 in the right column in FIG. 3.

Note the thick frame in that the right column in FIG. 11 indicates the panel pixel b2. Further, the hatched area in the left column in FIG. 11 indicates the video pixels expressed by the panel pixels a1, a2, b1, and b2. Among those video pixels, the thick frame indicates the video pixel expressed by the panel pixel b2.

As illustrated in FIG. 11, in the unit period f-1, the panel pixels a1, a2, b1, and b2 sequentially express video pixels A1, A3, C1, and C3 that are hatched, respectively. The arrow extending diagonally upward to the right of the panel pixel in the unit period f-1 indicates shifting from the projection position in the unit period f-4 of the previous frame.

When the rear end period in the unit period f-1 arrives, the optical path shifting element 230 shifts the projection position from the reference position, which is indicated by the broken line f-1, by 0.5 panel pixels in the rightward direction and 0.5 panel pixels in the downward direction in the drawing.

In the subsequent unit period f-2, the panel pixels a1, a2, b1, and b2 sequentially express video pixels B2, B4, D2, and D4 that are hatched, respectively.

When the rear end period in the unit period f-2 arrives, the optical path shifting element 230 shifts the projection position from the projection position, which is indicated by the broken line f-2, by 0.5 panel pixels in the leftward direction in the drawing.

In the subsequent unit period f-3, the panel pixels a1, a2, b1, and b2 sequentially express video pixels B1, B3, D1, and D3 that are hatched, respectively.

When the rear end period in the unit period f-3 arrives, the optical path shifting element 230 shifts the projection position from the projection position, which is indicated by the broken line f-3, by 0.5 panel pixels in the leftward direction and 0.5 panel pixels in the downward direction in the drawing.

In the subsequent unit period f-4, the panel pixels a1, a2, b1, and b2 sequentially express video pixels C0, C2, E0, and E2 that are hatched, respectively.

When the rear end period in the unit period f-4 arrives, the optical path shifting element 230 shifts the projection position from the projection position, which is indicated by the broken line f-4, by 0.5 panel pixels in the rightward direction and 1.0 panel pixel in the upward direction in the drawing, and the projection position returns to the reference position.

Herein, before describing display quality in the embodiment, description is made on degradation of display quality caused in a projection-type display device according to a comparative example.

FIG. 19 is a diagram illustrating a relationship of video pixels expressed by one panel pixel in the unit periods f-1 to f-4 in the comparative example.

Similarly to the first embodiment, the projection position in the unit period f-1 is set as a reference position. In the unit period f-2, the projection position is shifted from the reference position in the unit period f-1 by 0.5 panel pixels in the rightward direction in the drawing. In the unit period f-3, the projection position is shifted from the projection position in the unit period f-2 by 0.5 panel pixels in the downward direction. In the unit period f-4, the projection position is shifted from the projection position in the unit period f-3 by 0.5 panel pixels in the leftward direction. After the unit period f-4, the projection position is shifted from the projection position in the unit period f-4 by 0.5 panel pixels in the upward direction, and returns to the reference position.

Description is made on the video pixels expressed by the panel pixels in the unit periods f-1 to f-4 in the comparative example.

Description is made while using FIG. 3 for comparison with the embodiment. The panel pixels a1, a2, b1, and b2 sequentially express video pixels A1, A3, C1 and C3 in the unit period f-1. Similarly, the panel pixels a1, a2, b1, and b2 sequentially express video pixels A2, A4, C2, and C4 in the unit period f-2, sequentially express video pixels B2, B4, D2, and D4 in the unit period f-3, and sequentially express video pixels B1, B3, D1, and D3 in the unit period f-4.

FIG. 20 is a diagram for describing display unevenness in the comparative example. A microlens is provided for each panel pixel in the liquid crystal panel 100 in order to increase light use efficiency, as described above. Thus, the brightness of the panel pixels is not even. When the optical path is not shifted, the brightness in the vicinity of the center is higher, and becomes lower toward the outer side from the vicinity of the center, as illustrated in the left column in FIG. 20. Note that a frame Ppx indicates an outer edge of the panel pixel at the reference position in the liquid crystal panel 100.

In the comparative example, the panel pixels visually recognized in this manner are shifted sequentially from the reference position by 0.5 panel pixels in the rightward direction, the downward direction, the leftward direction, and the upward direction in the unit periods f-1 to f-4, as illustrated in the right column in FIG. 20.

Therefore, when viewed through a single frame period, in the panel pixel, a bright region circulates along a path indicated by the arrow in the figure. As a result, a bright region visually recognized as a relatively bright region and a dark region other than the bright region separately emerge. Such a difference between the bright region and the dark region is visually recognized as the display unevenness. This display unevenness is easily visually recognized when a relatively bright still image is displayed.

In the comparative example, the cause of display unevenness that occurs in a single frame period is that the panel pixel is larger than the video pixel, resulting in uneven distribution of areas with significant overlap and those with minimal overlap due to shifting. In the comparative example, within the grid-like dark regions that occur during a single frame period, the areas where the vertical and horizontal lines intersect become particularly dark. Conversely, the optical path of the shift is adjusted so that the center of the brightly visible panel pixel passes through the darkened region. Specifically, among the video pixels expressed by a single panel pixel, at least one or more video pixels are expressed by being shifted by one or more panel pixels in the up-down direction or the right-left direction. More specifically, among the video pixels in the two rows and the two column that are indicated by the thick frame in FIG. 3, at least one or more video pixels are represented by a panel pixel different from one for other video pixels. It is assumed that, when a single frame period is viewed as a unit, display unevenness can be resolved by changing the optical path of the shift in this manner.

However, from the projection position in a certain unit period to the projection position in the subsequent unit period, the shifting amount and the shifting change direction of the optical path become uneven. Thus, there is a problem that, due to shifting of the optical path, display unevenness, which is different from one described above, is visually recognized.

In view of this, in the first embodiment, when returning from unit period f-4 to unit period f-1, the optical path is shifted in the upward direction by 1.0 panel pixel. Moreover, the lamp unit 2102 is turned off during while shifting the optical path, as illustrated in FIG. 6.

Specifically, in the first embodiment, the lamp unit 2102 can control the light source by turning it on/off, thereby enabling/disabling light emission. In the first embodiment, when the control signal Lmp is at the H level, the lamp unit 2102 is instructed to turn on. When the control signal Lmp is at the L level, the lamp unit 2102 is instructed to turn off.

In the first embodiment, a period during which the control signal Lmp is at the L level to instruct the lamp unit 2102 to turn off is the rear end period in each of the unit periods, in other words, the period during which the optical path shifting element 230 shifts the optical path.

In the first embodiment, it is hypothetically assumed that the lamp unit 2102 is not turned off. In the configuration thus assumed, among the projection positions, the projection position in the unit periods f-1, f-2, and f-3 are relatively narrow ranges. Thus, the ranges have significant overlap, and are visually recognized relatively brightly. In contrast, the projection position in the unit period f-4 is away from the other projection positions, and the shifting amount from the unit period f-4 to the unit period f-1 is large. Thus, the projection period has less overlap with the projection positions in the other unit periods, and is visually recognized relatively dark. In the first embodiment, in actuality, when the optical path is shifted, the lamp unit 2102 is turned off. Thus, display unevenness caused by an uneven shifting amount and an uneven shifting change direction can be alleviated. Further, according to the first embodiment, display unevenness caused by uneven distribution of areas with significant overlap and those with minimal overlap due to shifting can be suppressed.

As illustrated in FIG. 5, in the first embodiment in which the optical path is shifted, the lamp unit 2102 is turned off when the optical path is shifted. However, the shifting amount of the optical path from a certain unit period to the subsequent unit period is uneven. Thus, there is room for improvement in display unevenness caused by an even shifting amount.

In view of this, description is made on a second embodiment that can further suppresses display unevenness caused by an even shifting amount as compared to the first embodiment.

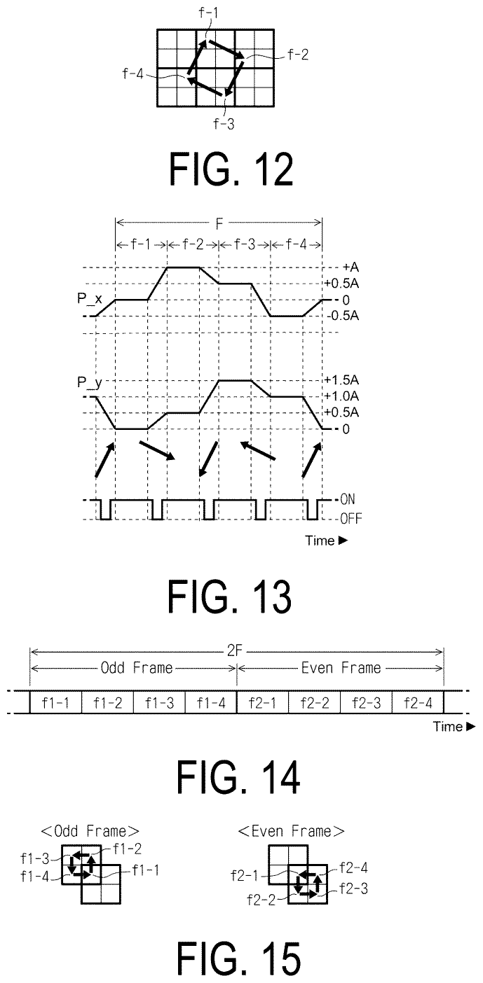

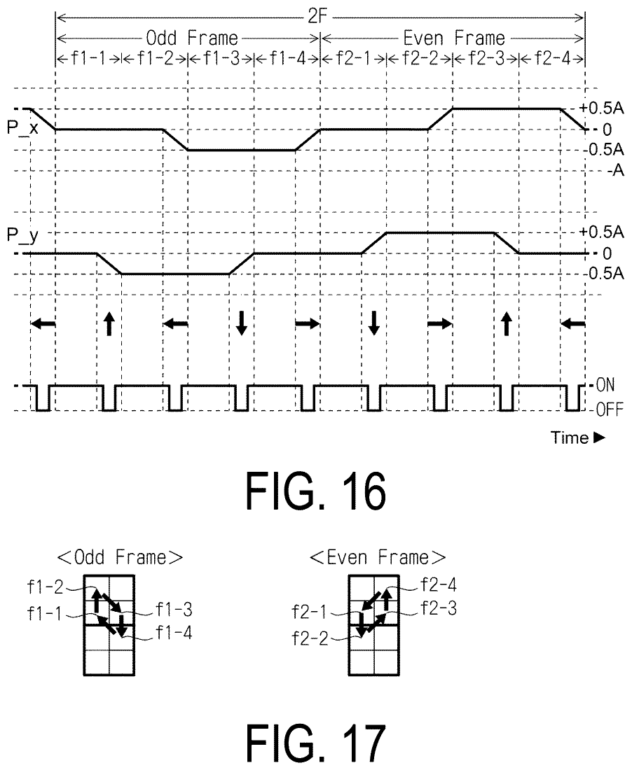

FIG. 12 is a diagram illustrating a relationship of video pixels expressed by one panel pixel in the unit periods f-1 to f-4 in the second embodiment.

The projection position in the unit period f-1 is set as a reference position. In the unit period f-2, the projection position is shifted from the reference position in the unit period f-1 by 1.0 panel pixel in the rightward direction and 0.5 panel pixels in the downward direction in the drawing. In the unit period f-3, the projection position is shifted from the projection position in the unit period f-2 by 0.5 panel pixels in the leftward direction and 1.0 panel pixel in the downward direction. In the unit period f-4, the projection position is shifted from the projection position in the unit period f-3 by 1.0 panel pixel in the leftward direction and 0.5 panel pixels in the upward direction. After the unit period f-4, the projection position is shifted from the projection position in the unit period f-4 by 0.5 panel pixels in the leftward direction and 1.0 panel pixel in the upward direction, and returns to the reference position.

FIG. 13 is a diagram illustrating waveforms of the control signals P_x and P_y to the optical path shifting element 230, and the like when the panel pixels represent the video pixels as illustrated in FIG. 12.

The description overlapping with FIG. 6 is omitted. In the second embodiment, the control signal P_x has a level of one of four values including −0.5 A, 0, +0.5 A, and +1.0 A. When the control signal P_x is +1.0 A, the projection position is shifted by 1.0 panel pixel in the leftward direction with respect to the reference position. Further, in the second embodiment, the control signal P_y has a level of one of four values including 0, +0.5 A, +1.0 A, and +1.5 A. When the control signal P_x is +1.5 A, the projection position is shifted by 1.5 panel pixels in the downward direction with respect to the reference position.

Next, description is made on the video pixels expressed by the panel pixels in the unit periods f-1 to f-4 in the second embodiment.

Description is made while using FIG. 3 for comparison with the first embodiment. The panel pixels a1, a2, b1, and b2 sequentially express video pixels A1, A3, C1, and C3 in the unit period f-1. Similarly, the panel pixels a1, a2, b1, and b2 sequentially express video pixels B3, B5, D3, and D5 in the unit period f-2, sequentially express video pixels D2, D4, F2, and F4 in the unit period f-3, and sequentially express video pixels C0, C2, E0, and E2 in the unit period f-4.

According to the second embodiment, similarly to the first embodiment, display unevenness caused by uneven distribution of areas with significant overlap and those with minimal overlap due to shifting van be suppressed. The second embodiment is similar to the first embodiment in that the lamp unit 2102 is turned off when the optical path is shifted. However, the shifting amount and the shifting change direction can be aligned, and hence display unevenness caused by unevenness thereof can be suppressed more than that in the first embodiment.

Further, in the second embodiment, the shifting amount of the optical path is increased, and hence the overlapping range due to shifting is increased and averaged. In this sense, display unevenness can also be suppressed.

Next, a third embodiment is described. In the first embodiment and the second embodiment, the cycle of the period during which the optical path is shifted is a single frame period, but the configuration is not limited thereto.

In view of this, description is made on the third embodiment and a fourth embodiment in which the cycle of the period during which the optical path is shifted is a double frame period.

FIG. 14 is a diagram for describing a relationship between a double frame period and unit periods in the projection-type display device according to the third embodiment.

In the third embodiment, one cycle of shifting of the optical path is a double frame (2F) period. For the sake of convenience, the two frame periods are divided into a chronologically preceding odd frame period and a chronologically succeeding even frame.

The odd frame period is divided into four unit periods. In order to distinguish the four unit periods in the odd frame period from each other, reference signs f1-1, f1-2, f1-3, and f1-4 are assigned in a chronological order for the sale of convenience. Similarly, the even frame period is divided into four unit periods. In order to distinguish the four unit periods in the even frame period from each other, reference signs f2-1, f2-2, f2-3, and f2-4 are assigned in a chronological order for the sake of convenience.

The projection position in the unit period f1-1 is set as a reference position. In the unit period f1-2, the projection position is shifted from the reference position in the unit period f1-1 by 0.5 panel pixels in the upward direction in the drawing. In the unit period f1-3, the projection position is shifted from the projection position in the unit period f1-2 by 0.5 panel pixels in the leftward direction. In the unit period f1-4, the projection position is shifted from the projection position in the unit period f1-3 by 0.5 panel pixels in the downward direction. After the unit period f1-4, the projection position is shifted from the projection position in the unit period f1-4 by 0.5 panel pixels in the rightward direction, and returns to the reference position.

The projection position in the unit period f2-1 is a reference position. In the unit period f2-2, the projection position is shifted from the projection position in the unit period f2-1 by 0.5 panel pixels in the downward direction. In the unit period f2-3, the projection position is shifted from the projection position in the unit period f2-2 by 0.5 panel pixels in the rightward direction. In the unit period f2-4, the projection position is shifted from the projection position in the unit period f2-3 by 0.5 panel pixels in the upward direction. After the unit period f2-4, the projection position is shifted from the projection position in the unit period f2-4 by 0.5 panel pixels in the leftward direction, and returns to the reference position.

FIG. 15 is a diagram illustrating waveforms of the control signals P_x and P_y to the optical path shifting element 230, and the like when the panel pixels represent the video pixels as illustrated in FIG. 14. As this is the same as the description for FIG. 6, it is unnecessary to describe it in particular.

In the third embodiment, description is made on the video pixels expressed by the panel pixels in the unit periods f1-1 to f1-4 in the odd frame period and the unit periods f2-1 to f2-4 in the even frame period. Note that, for the sake of convenience, description is made while focusing only on the panel pixels b1 and b2 in FIG. 3.

The panel pixels b1 and b2 sequentially express the video pixels D2 and D4 in the unit period f1-1 in the odd frame period. Similarly, the panel pixels b1 and b2 sequentially express the video pixels C2 and C4 in the unit period f1-2, sequentially express the video pixels C1 and C3 in the unit period f1-3, and sequentially express the video pixels D1 and D3 in the unit period f1-4.

The panel pixels b1 and b2 sequentially express the video pixels D2 and D4 in the unit period f2-1 in the even frame period. Similarly, the panel pixels b1 and b2 sequentially express the video pixels E2 and E4 in the unit period f2-2, sequentially express the video pixels E3 and E5 in the unit period f2-3, and sequentially express the video pixels D3 and D5 in the unit period f2-4.

According to the third embodiment, a region Led brightened by shifting in the unit periods f2-1 to f2-4 in the even frame period overlaps with a vicinity of a region Ded (see FIG. 20) darkened by shifting in the unit periods f1-1 to f1-4 in the odd frame period. In other words, the region darkened in the even frame period overlaps with the region brightened in the odd frame period.

Thus, in the third embodiment, the relatively bright part due to shifting of the optical path in the panel pixel also overlaps with the darkened region, and thus display unevenness can be suppressed. Further, when the optical path is shifted, the lamp unit 2102 is turned off. Thus, display unevenness caused by shifting the optical path can be suppressed.

The projection-type display device according to the fourth embodiment is similar to that of the third embodiment in that the unit periods f1-1 to f1-4 in the odd frame period and the unit periods f2-1 to f2-4 in the even frame period are one cycle of shifting of the optical path.

In the fourth embodiment, the projection position in the unit period f1-1 is also set as a reference position. In the unit period f1-2, the projection position is shifted from the reference position in the unit period f1-1 by 0.5 panel pixels in the upward direction in the drawing. In the unit period f1-3, the projection position is shifted from the projection position in the unit period f1-2 by 0.5 panel pixels in the rightward direction and 0.5 panel pixels in the downward direction. In the unit period f1-4, the projection position is shifted from the projection position in the unit period f1-3 by 0.5 panel pixels in the downward direction. After the unit period f1-4, the projection position is shifted from the projection position in the unit period f1-4 by 0.5 panel pixels in the leftward direction and 0.5 panel pixels in the upward direction, and returns to the reference position.

The projection position in the unit period f2-1 is a reference position. In the unit period f2-2, the projection position is shifted from the projection position in the unit period f2-1 by 0.5 panel pixels in the downward direction. In the unit period f2-3, the projection position is shifted from the projection position in the unit period f2-2 by 0.5 panel pixels in the rightward direction and 0.5 panel pixels in the upward direction. In the unit period f2-4, the projection position is shifted from the projection position in the unit period f2-3 by 0.5 panel pixels in the upward direction. After the unit period f2-4, the projection position is shifted from the projection position in the unit period f2-4 by 0.5 panel pixels in the leftward direction and 0.5 panel pixels in the downward direction, and returns to the reference position.

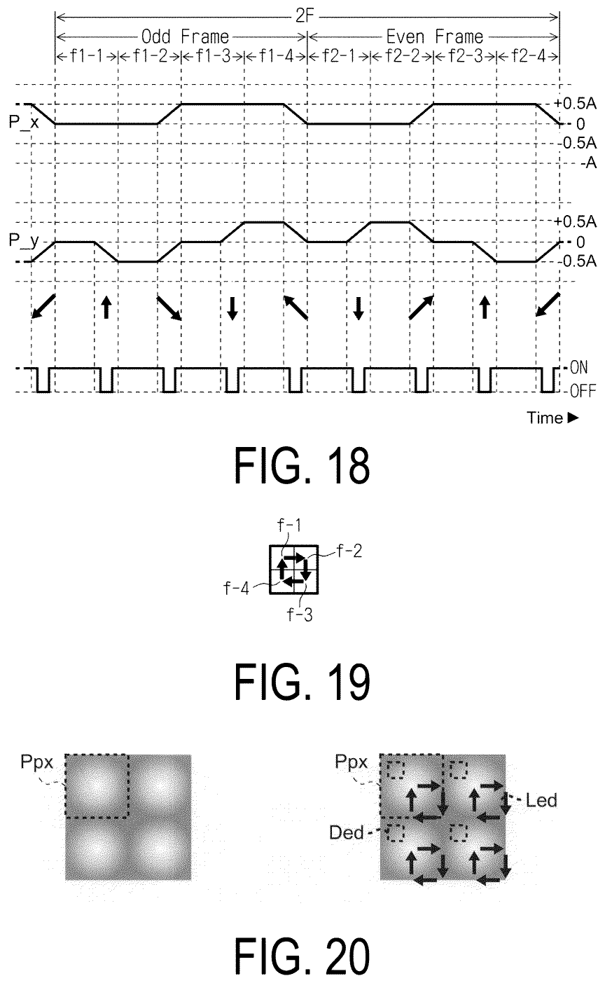

FIG. 18 is a diagram illustrating waveforms of the control signals P_x and P_y to the optical path shifting element 230, and the like when the panel pixels represent the video pixels as illustrated in FIG. 17. As this is the same as the description for FIG. 6, it is unnecessary to describe it in particular.

In the fourth embodiment, description is made on the video pixels expressed by the panel pixels in the unit periods f1-1 to f1-4 in the odd frame period and the unit periods f2-1 to f2-4 in the even frame period. Note that, for the sake of convenience, description is made while focusing only on the panel pixels b1 and b2 in FIG. 3.

The panel pixels b1 and b2 sequentially express the video pixels D1 and D3 in the unit period f1-1 in the odd frame period. Similarly, the panel pixels b1 and b2 sequentially express the video pixels C1 and C3 in the unit period f1-2, sequentially express the video pixels D2 and D4 in the unit period f1-3, and sequentially express the video pixels E2 and E4 in the unit period f1-4.

The panel pixels b1 and b2 sequentially express the video pixels D1 and D3 in the unit period f2-1 in the even frame period. Similarly, the panel pixels b1 and b2 sequentially express the video pixels E1 and E3 in the unit period f2-2, sequentially express the video pixels D2 and D4 in the unit period f2-3, and sequentially express the video pixels C2 and C4 in the unit period f2-4.

In the fourth embodiment, which is different from the third embodiment, the darkened region has a parallelogram shape, and the brightened region also has a parallelogram shape in the odd frame period and the even frame period. However, according to the fourth embodiment, the region brightened in the even frame period overlaps with a part of the region darkened in the odd frame period. Further, the region darkened in the even frame period overlaps a part of the region brightened in the odd frame period.

Thus, in the fourth embodiment, the relatively bright part due to shifting of the optical path in the panel pixel also overlaps with the darkened region, and thus display unevenness can be suppressed. Further, when the optical path is shifted, the lamp unit 2102 is turned off. Thus, display unevenness caused by shifting the optical path can be suppressed.

In the first to the fourth embodiments (hereinafter, referred to as the embodiment and the like) that are described above, various modifications or applications are possible as described below.

In the embodiment and the like, the liquid crystal panel 100 is a transmission type, but may be a reflection type.

Further, in the embodiment and the like, the period during which the lamp unit 2102 is turned off (or dimmed) is a part of the period during which the optical path is shifted. Alternatively, the period during which the lamp unit 2102 is turned off (or dimmed) may be the entire period during which the optical path is shifted.

In the embodiment and the like, the timing at which the optical path shifting element 230 starts shifting the optical path is the rear end period corresponding to a vertical scanning period in a unit period. However, there may be a time delay. In such a case, for example, the processing circuit 21 may be configured to control the optical path shifting element in anticipation of any time delay so that the image formed by the liquid crystal panel 100 during a unit period is shifted to the projection position corresponding to the unit period.

In the embodiment and the like, a single frame period is divided into four unit periods. That is, in the description, “4” is an example of k, which is the number of unit periods included in a single frame period. k is not limited to “4”. Specifically, as long as the shifting amount of the optical path from a certain unit period to the subsequent unit period is 1.0 panel pixels or more in the up-down direction or the right-left direction, k may be “2”, “3”, or an integer equal to or greater than “5”.

For example, in the first embodiment, the shifting amount from the unit period f-4 to the unit period f-1 is larger than the other shifting amounts. In other words, the shifting speed from the unit period f-4 to the unit period f-1 is higher than the other shifting speeds. Thus, there may be adopted a configuration in which the light-off period or the dimmed light amount of the lamp unit 2102, or both of them are controlled according to the shifting amount and the shifting speed.

There may be adopted a configuration in which the optical path shifting is switched according to a type of a video represented by the video data Vid-in, such as a line image and a natural image.

For example, the processing circuit 21 may be configured to detect a type of a video represented by the video data Vid-in. For example, when the type is a line image, the optical path shifting may be switched to one in the third or fourth embodiment. When the type is a natural image, the optical path shifting may be switched to one in the second embodiment. Note that the line image used herein refers to a video composed of a grid line, a table, a character, a number, or the like in OA, where a gradation level change between adjacent video pixels is significant. The natural image refers to a video where a gradation level change between adjacent video pixels is minimal, such as a photograph and a painting.

Note that, in the embodiment and the like, the lamp unit 2102 emits white light, and the two dichroic mirrors 2108 separates the light into red (R), green (G), and blue (B) light. The configuration is not limited thereto, and there may be adopted a configuration in which three lamp units that individually emit red light, green light, and blue light are prepared to cause the emitted red light, green light, and blue light to be incident sequentially on the liquid crystal panels 100R, 100G, and 100B.

In this description, the right-left direction is an example of a “first direction”, the up-down direction is an example of a “second direction”, and the lamp unit 2102 is an example of a “light source”.

For example, in FIG. 5, the shifting amount from the unit period f-1 to the unit period f-2 is an example of a “first shifting amount”, and the shifting amount from the unit period f-4 to the unit period f-1 is an example of a “second shifting amount”. Further, for example, FIG. 11 illustrates an example in which all the shifting amount from the unit period f-1 to the unit period f-2, the shifting amount from the unit period f-2 to the unit period f-3, the shifting amount from the unit period f-3 to the unit period f-4, and the shifting amount from the unit period f-4 to the unit period f-1 in the unit periods f-1 to f-4 forming the single frame are the same.

From the embodiments illustrated above, the following aspects can be ascertained, for example.

A projection-type display device according to a first aspect includes a light source according to emit light, a liquid crystal panel including a panel pixel on which light emitted from the light source is incident, an optical path shifting element configured to shift an optical path of a projection light from the panel pixel so that a position of the projection pixel is changed for each of k unit periods from a first unit period to a k-th unit period in a single frame period, k being an integer equal to or greater than 2, and a display control circuit configured to control the light source, the liquid crystal panel, and the optical path shifting element, wherein the display control circuit supplies a data signal to the panel pixel for each of the unit periods, the data signal corresponding to a gradation level designated by pixel data forming video data, and controls shifting of the optical path for each of the unit periods with respect to the optical path shifting element, the optical path shifting element shifts, during at least one unit period of the unit periods, the optical path of the projection light by one or more panel pixels in at least one direction of a first direction and a second direction in which the projection pixels are arrayed, and the light source is turned off or dimmed for at least a part or an entirety of a period during which the optical path is shifted.

According to the projection-type display device according to the first aspect, when the optical path is shifted, the light source is turned off or dimmed. Thus, display unevenness can be suppressed.

In a projection-type display device according to a second aspect, which is a specific aspect of the first aspect, the light source is an LED or a laser light source.

In a projection-type display device according to a third aspect, which is another specific aspect of the first aspect, a shifting amount of an optical path for each of the k unit periods includes a first shifting amount and a second shifting amount different from the first shifting amount.

A shifting amount of an optical path for each of the k unit periods is uniform.

What is claimed is:

1. A projection-type display device comprising:
a light source according to emit light;
a liquid crystal panel including a panel pixel on which light emitted from the light source is incident;
an optical path shifting element configured to shift an optical path of a projection light from the panel pixel so that a position of the projection pixel is changed for each of k unit periods from a first unit period to a k-th unit period in a single frame period, k being an integer equal to or greater than 2; and
a display control circuit configured to control the light source, the liquid crystal panel, and the optical path shifting element, wherein
the display control circuit:
supplies a data signal to the panel pixel for each of the unit periods, the data signal corresponding to a gradation level designated by pixel data forming video data; and
controls shifting of the optical path for each of the unit periods with respect to the optical path shifting element,
the optical path shifting element shifts, during at least one unit period of the unit periods, the optical path of the projection light by one or more panel pixels in at least one direction of a first direction and a second direction in which the projection pixels are arrayed, and
the light source is turned off or dimmed for at least a part or an entirety of a period during which the optical path is shifted.

2. A projection-type display device according to claim 1, wherein
the light source is an LED or a laser light source.

3. A projection-type display device according to claim 1, wherein
a shifting amount of an optical path for each of the k unit periods includes a first shifting amount and a second shifting amount different from the first shifting amount.

4. A projection-type display device according to claim 1, wherein
a shifting amount of an optical path for each of the k unit periods is uniform.
